(19) United States
(12) Patent Application Publication
(10) Pub. No.: US 2014/0285175 A1
(43) Pub. Date: Sep. 25, 2014

(54) REFERENCE VOLTAGE GENERATING CIRCUIT, INTEGRATED CIRCUIT AND VOLTAGE OR CURRENT SENSING DEVICE

(71) Applicant: Jean Lasseuguette, L'UNION (FR)

(72) Inventor: Jean Lasseuguette, L'UNION (FR)

(73) Assignee: FREESCALE SEMICONDUCTOR, INC., AUSTIN, TX (US)

(21) Appl. No.: 14/354,284

(22) PCT Filed: Nov. 4, 2011
(86) PCT No.: PCT/IB2011/003210

§ 371 Date: Apr. 25, 2014

(51) Int. Cl. G05F 3/08

(52) U.S. Cl. CPC G05F 3/08
USPC 323/313

(57) ABSTRACT

A reference voltage generating circuit comprising a first bandgap voltage source arranged to output a first bandgap voltage exhibiting a first type deviation in response to a strain applied at die level in a given direction; a second bandgap voltage source arranged to output a second bandgap voltage exhibiting a second type deviation in response to a strain applied at die level in the given direction, said second type deviation being opposite to the first type deviation of the first bandgap voltage; and an adding circuit arranged to add the first bandgap voltage and the second bandgap voltage, and to output a temperature drift and strain drift compensated reference voltage.

### FIELD OF THE INVENTION

This invention relates to a reference voltage generating circuit, an integrated circuit, and a battery voltage or current sensing device.

### BACKGROUND OF THE INVENTION

Reference voltage accuracy is of utmost importance in electronic sensing devices. In particular, there is required that the reference voltage keeps stable as a function of temperature, for operation across the whole temperature range of such a device. U.S. Pat. No. 5,103,159 discloses a voltage source of the so-called ‘bandgap’ type, which provides a reference voltage having a limited temperature drift. Sources of this type use the known relationship of dependency between the energy interval existing between the valence bands and the conduction bands of a semiconductor, on one hand, and the temperature, on the other hand, to achieve compensations that make the reference voltage as stable as possible as a function of the temperature.

However, some applications require that accuracy and stability of the reference voltage be achieved not only during operation across the whole operational temperature range, but also along the lifetime of the electronic device. For example, occurrence of strain during life of the product, e.g. deformation produced in the voltage generating circuit at die level as the result of mechanical stress, may be responsible for changes in the reference voltage due to the piezo-electric effect.

Known solutions are not effective against the effects of strain applied at die level to the integrated circuit embodying the reference voltage generation circuit, leading to possible loss of performance over time.

### SUMMARY OF THE INVENTION

The present invention provides a reference voltage generating circuit, an integrated circuit, and a battery voltage or current sensing device as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 shows a block diagram of an example of an embodiment of a reference voltage generating circuit.

FIG. 2 shows a chart of voltage drifts as a function of temperature.

FIG. 3 shows a chart illustrating voltage drifts as a function of strain intensity.

FIG. 4 shows a circuit diagram of an example of embodiment suitable for the example of FIG. 1.

FIG. 5 shows a top view of an example of an integrated circuit incorporating the circuit of FIG. 1 and FIG. 4.

FIG. 6 shows a cross sectional view of the integrated circuit of FIG. 5.

FIG. 7 shows an example of a battery sensing device incorporating the integrated circuit of FIG. 1 and FIG. 4.

### DETAILED DESCRIPTION OF THE PREFERRED EMBODIMENTS

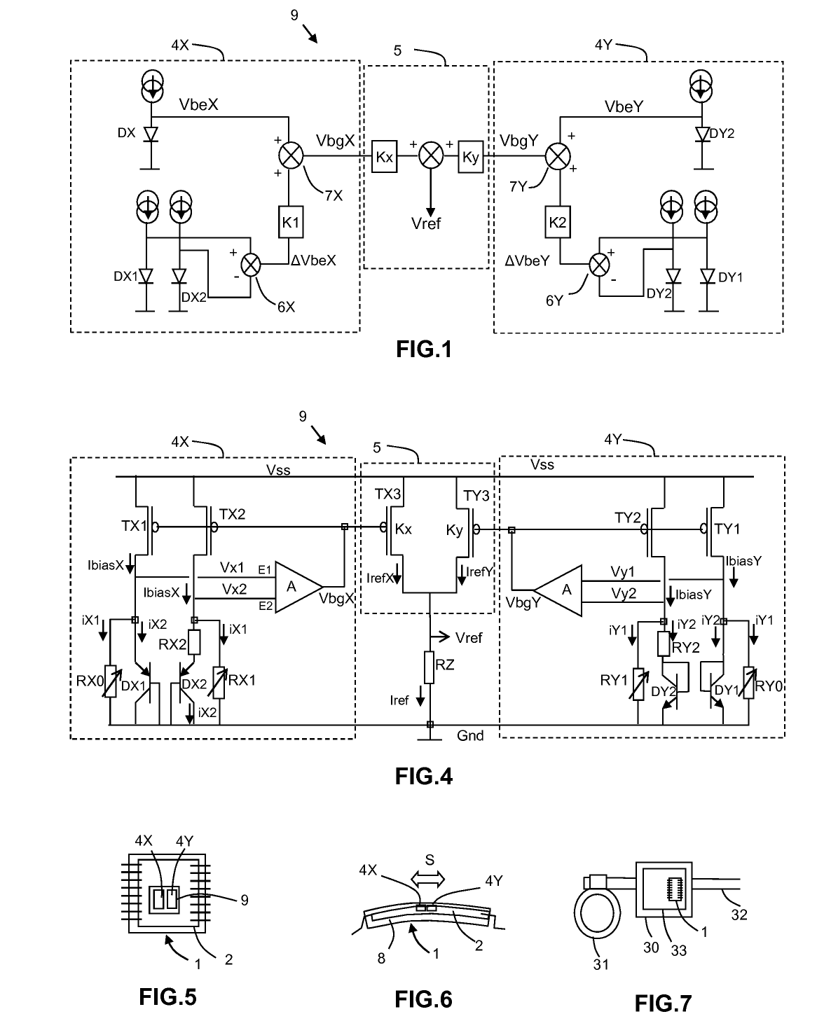

FIG. 1 shows a reference voltage generation circuit 9 comprising a first voltage source 4X, a second voltage source 4Y, and an adding circuit 5 arranged to add the outputs of the first and second voltage sources 4X and 4Y, respectively. The voltage sources 4X and 4Y can be, for instance of ‘bandgap’ type, so as to exhibit a low variation of the generated voltage as a function of the temperature.

A voltage source of bandgap type, also referred to as a ‘bandgap voltage source’, generally has first and second diodes through which there flow different currents (or the same currents, but in this case the diodes are with different P-N junction surfaces) and a looped differential amplifier amplifying the voltage difference between the voltage drops across the cathode and anode terminals of each of the two diodes, respectively, and supplying the diodes with current. The principle of generating an accurate voltage which is little dependent on temperature using such bandgap voltage source is known, for example, from document U.S. Pat. No. 5,103,159 mentioned in the introduction of the present description. Therefore, the principle of operation of such a bandgap voltage source shall not be described in more details here.

In the example shown in FIG. 1, the first voltage source 4X and the second voltage source 4Y are of the bandgap type and have, for example, the architecture which shall now be described. It shall be noted, however, that the bandgap voltage sources 4X and 4Y may be implemented based on any other architecture suitable for the specific implementation.

In the shown example, the first voltage source 4X comprises on the one hand a first P-N junction DX, having a first forward voltage drop VbeX. The value of VbeX changes when the temperature changes, such change being also referred to as a temperature drift. In one example, this temperature drift is, e.g. a ‘negative’ temperature drift, meaning that VbeX decreases when the temperature increases or vice versa. This result may be achieved by using the properties of bandgap voltage sources.

On the other hand, the first bandgap voltage source 4X comprises a subtracting circuit 6X arranged to subtract the forward voltage drop of one P-N junction DX2 from the forward voltage drop of another P-N junction DX1. Two current sources of any suitable implementation are arranged to cause respective currents flow through both P-N junctions. The two currents are different if the respective surfaces of the P-N junctions are the same, or, conversely, the respective surfaces of the P-N junctions are different if the currents are the same.

The resulting difference ΔVbeX, provided by the output of the subtracting circuit 6X, may give a voltage value having a so-called ‘positive’ temperature drift, by correctly choosing the implementation parameters at die level. In that case, the voltage at the output of the subtracting circuit 6X increases when the temperature increases. The difference ΔVbeX is then multiplied by a first weighting coefficient K1.

It will be appreciated that the positive and negative type of the above mentioned temperature drifts may be reversed one to the other.

For instance, the P-N junctions DX, DX1 and DX2 may be P-N junctions of any one of the following semiconductor devices: a diode, a Field Effect Transistor (FET) of the P-type or N-type category (e.g. a PMOS or NMOS transistor, respectively) connected as a diode, a Bipolar Junction Transistor (BJT) or an Insulated Gate Bipolar Transistor (IGBT) of the P-type or N-type category (e.g., a PNP or NPN transistor, respectively) connected as a diode, or any other suitable semiconductor device.

In the shown example, the reference voltage generation circuit 9 further comprises an adding circuit 7X with two inputs, respectively arranged to receive the first forward voltage drop VbeX on one input, and the difference ΔVbeX on the other input. The adding circuit 7X is thus arranged to perform the following sum:

VbgX=VbeX+K1.ΔVbeX (1)

where VbgX denotes the output voltage of the first bandgap voltage source 4X.

Referring to above equation (1), the positive temperature drift of K1.ΔVbeX may be arranged to compensate for the negative temperature drift of VbeX, whereby the output VbgX may be little dependent on temperature, thanks to the bandgap effect. For this reason, voltage VbgX is known as a ‘bandgap voltage’. The selection of the P-N junctions characteristics, the value of the currents flowing there through, and the selection of the weighting coefficient K1 enable to achieve an adequate compensation and, consequently, a very small temperature drift of VbgX.

It will be appreciated that the two-level architecture of the bandgap voltage source 4X of FIG. 1 allows obtaining a temperature drift compensation at both first and second orders.

In the example shown in FIG. 1, the reference voltage generating circuit 9 further comprises a second voltage source 4Y of the bandgap type.

While this should not be interpreted as limiting use of other embodiments, the second voltage source 4Y may be similar in at least its principle and architecture, possibly also in its practical implementation, to the first voltage source 4X whose functional architecture has been described in the foregoing.

For this reason, the presentation of the bandgap voltage source 4Y with reference to FIG. 1 is similar to that of bandgap voltage source 4X and shall not be repeated in the present description. It shall just be noted that the reference signs of the constituting elements of, and names of the voltages generated in the voltage source 4Y are the same as for voltage source 4X except that the letter ‘X’ therein is replaced by letter ‘Y’. Also, the voltage difference ΔVbeY is multiplied by a second weighting coefficient K2 instead of weighting coefficient K1 for ΔVbeX, and thus the adding circuit 7Y is arranged to perform the following sum:

VbgY=VbeY+K2.ΔVbeY (2)

in which the positive temperature drift of K2.ΔVbeY is suitable for compensating for the negative temperature drift of VbeY, VbgY being the voltage at the output of the second voltage source 4Y.

In the shown embodiment, the P-N junctions DY1 and DY2 of the bandgap voltage source 4Y are formed by diode-connected bipolar transistors of a conduction type which is different from the conduction type of the P-N junction of the diode-connected bipolar transistors DX1 and DX2 of the first bandgap voltage source 4X. For instance DY1 and DY2 may be N-type transistors, e.g. e NPN bipolar transistors, whereas DX1 and DX2 are P-type transistors, e.g. PNP bipolar transistors.

It will be appreciated, further, that the temperature drift characteristics of VbeX and VbeY may differ one from the other, as well as the weighting coefficients K1 and K2. Therefore, the respective output voltages VbgX and VbgY of voltage sources 4X and 4Y may exhibit different temperature drifts.

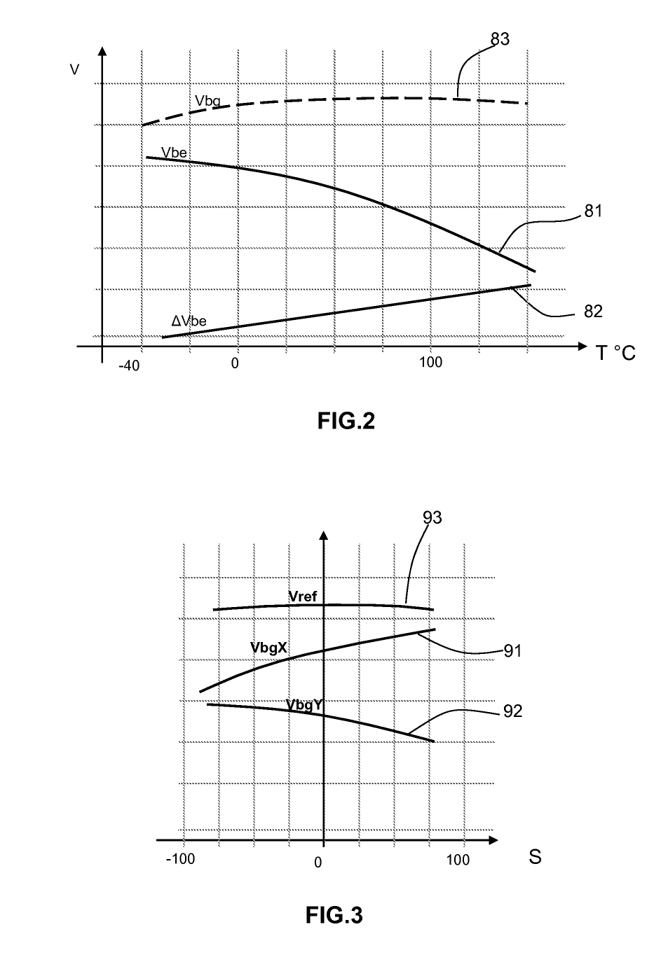

The chart of FIG. 2 shows one example of a curve 81 and of a curve 82 illustrating the Vbe voltage deviation (where Vbe may be VbeX or VbeY of the example of embodiment of FIG. 1) and the ΔVbe voltage deviation (where ΔVbe may similarly be ΔVbeX or ΔVbeY of the embodiment of FIG. 1), respectively, as a function of the operational temperature.

It can be noted that, as a result of the architecture of voltage sources 4X and 4Y as described above, the ΔVbe voltage exhibits a smaller temperature drift than the Vbe voltage.

As can be seen further on curve 83 depicted in dotted line in the chart of FIG. 2, the output of the bandgap voltage source (which may be voltage source 4X or voltage source 4Y) exhibits a very small temperature drift, namely still smaller than the temperature drift of both Vbe and ΔVbe. This result is achieved by the second order temperature drift compensation effect offered by the specific structure of the bandgap voltage sources 4X and 4Y when mutually arranged as described above.

Referring back to FIG. 1, the adding circuit 5 shown therein may be arranged to add the output voltages VbgX and VbgY of both first and second bandgap voltage sources 4X and 4Y, respectively. Thus, the possible remaining temperature drift of VbgX can be further compensated by the temperature drift of VbgY, or vice versa, as it will be detailed below.

Also, the second voltage source 4Y differs from the first voltage source 4X by its response to a mechanical stress which, as a consequence of the piezo-electric effect, may affect the value of the generated voltages VbgX and VbgY.

In one example, the first bandgap voltage VbeX exhibits a first type voltage deviation in response to a strain applied at die level in a given direction, and the second bandgap voltage VbeY exhibits a second type voltage deviation in response to a strain applied at die level in said direction. The first type voltage deviation and the second type voltage deviation are opposite one to the other, whatever the direction of application of the strain. They can be either an increase or a decrease, and the amplitude of the voltage deviation is function of the strain intensity.

The above feature may be achieved by correctly choosing the placement and/or orientation of the reference voltage sources 4X and 4Y on the semiconductor surface. Alternately or additionally, the reference voltage sources 4X and 4Y may be implemented in different layers of a multi-layer semiconductor device, depending in particular on the direction of the strain which may be expected to occur during the lifetime of the product under its usual conditions of operation. For instance, implementing the voltage sources in different layers may be preferred when the direction of the strain is along, or substantially aligned with the vertical to the semiconductor surface. Placing the voltage sources side by side in the same semiconductor layer at die level may be preferred when the direction of the strain is substantially parallel to the surface of the die. It will be apparent that a combination of the two options mentioned above, or any other possible arrangement available under the relevant manufacturing technology, may be suitable for the specific implementation.

In the adding circuit 5, there is performed the addition of the output voltage VbgX of the first bandgap voltage source 4X with a first weighting coefficient Kx and the output voltage VbgY of the second bandgap voltage source 4Y with a second weighting coefficient Ky. Weighting coefficients Kx and Ky may take into account, i.e., compensate for possible difference into the piezo-electric responses of P-N junctions of voltage source 4X and voltage source 4Y, respectively, when any such difference exists.

In the shown example, the first P-N junction DX may exhibit a first strain drift coefficient in response to a given strain S applied in the first direction, the first type voltage deviation being substantially proportional to an intensity of the strain S and to the first strain drift coefficient. Further, the second P-N junction DY may exhibit a second strain drift coefficient in response to the given strain S applied in the first direction, the second type voltage deviation being substantially proportional to the intensity of the strain and to the second strain drift coefficient.

In this example, the first strain drift coefficient has a sign opposite to the sign of the second strain drift coefficient. Weighting coefficients Kx and Ky may compensate for the ratio of the absolute values of the first and second strain drift coefficient.

Consequently, respective strain deviations of first and second bandgap voltage sources 4X and 4Y can be mutually compensated, at least at the first order. Thus, the overall dependency of the reference voltage generating circuit 9 to strain can be limited.

As illustrated in FIG. 3 by way of example only, curve 91 which illustrates the voltage VbgX as a function of the intensity of strain S, shows a derivative which has a sign opposite to the sign of the derivative of curve 92 illustrating voltage VbgY as a function of the amplitude of S. The derivative of the curve 91 is, e.g. positive which indicates (in mathematical terms) a positive deviation of VbgX, and the derivative of the curve 92 is negative, which corresponds to a positive deviation of VbgY. It shall be noted that this example is in no way limiting of the possible implementations, and that the first type deviation and the second type deviation may be reversed, as long as they remain opposite one to the other.

In FIG. 3, curve 91 further shows the variation of VbgX as a function of the strain intensity, curve 92 denotes the variation of VbgY against strain, and 93 denotes the variation of resulting Vref voltage against strain S, which exhibits a very low drift against strain.

As a result, the adding circuit 5 of the circuit 9 may output a reference voltage Vref value exhibiting a deviation or drift less than +/−0.15% over a temperature range of, e.g. [−40° C.,+125° C.], and for a lifetime of more than, e.g. 15 years.

With reference to the circuit diagram of FIG. 4, an example of implementation of the circuit of FIG. 1 shall now be described in further details.

In the shown example, each of the bandgap voltage sources 4X and 4Y comprises first and second current mirrored branches. Each branch comprises a first transistor, TX1 or TY1, and a second transistor, TX2 or TY2, mirrored with said first transistor, respectively. The first and second transistor are arranged as current sources controlled by one and the same control signal, VgbX or VgbY. Each of the bandgap voltage sources 4X and 4Y further comprises an operational amplifier A, arranged to provide the control signal for the currents sources. The value of the respective currents flowing through first and second branches which comprise the first transistor TX1 and the second transistor TX2, respectively, is the same. This value is labelled as IbiasX or IbiasY. Stated otherwise, the above branches are current mirrored, transistors TX1 and TX2 being mirrored.

The first branch further comprises a first diode, DX1 or DY1, arranged between the first transistor and the ground Gnd, and the second branch further comprises a second diode, DX2 or DY2, in series with an associated resistor, RX2 or RY2, arranged between the second transistor and the ground.

A first node between the first transistor and the first diode is connected to the ground via a first resistor, RX0 or RY0, and a second node between the second transistor on one side and the second diode and associated resistor on the other side, is connected to the ground via a second resistor, RX1 or RY1.

Finally, the operational amplifier is arranged to output the control signal as a function of the difference between voltage Vx1 or Vy1 at the first node, and voltage Vx2 or Vy2 at the second node.

Details of the above implementation will be elucidated in what follows.

For instance, the first bandgap voltage source 4X may comprise two identical transistors, namely a first transistor TX1 and a second transistor TX2, arranged as current sources controlled by the same control signal. These transistors may be Field Effect Transistors, for example P-type FET, e.g. PMOS transistors.

The drain of both first and second transistors TX1, TX2 may thus be connected to a supply rail to receive a supply voltage Vss.

The gate of both first and second transistors TX1 and TX2 may thus be connected together and also to the output of a differential amplifier, e.g. an operational amplifier A, which provides the control signal for the currents sources TX1 and TX2.

The source of TX1 is connected to one E1 of the inputs of the operational amplifier A, whereas the source of TX2 is connected to the other one E2 of the inputs of the operational amplifier A.

Further, the source of first transistor TX1 is connected to the ground Gnd via a diode DX1. In the shown example, diode DX1 may be implemented as a diode-connected transistor, for example a bipolar transistor of the NPN type. Further, the source of first transistor TX1 is connected to the ground Gnd via a first resistor RX0.

Further, the drain of second transistor TX2 is connected to the ground Gnd via a diode DX2 and a resistor RX2 connected in series. In the shown example, diode DX2 is also a diode-connected transistor, for example a bipolar transistor of the NPN type. Further, the drain of second transistor TX2 is connected to the ground Gnd via a second resistor RX1.

Any other option may be chosen for the implementation of DX1 and DX2 among, in particular, the options envisioned above with reference to FIG. 1.

RX0 and RX1 may have identical values, and may be implemented as variable resistors using MOS transistors in their conduction zone of operation, namely in the operational range where their current response as a function of the control voltage received on their gate is linear. RX0 and RX1 may be controlled to obtain desired values of the first and second weighting coefficients Kx and Ky, as will be further detailed below.

The operational amplifier A has a high gain and high input impedance, so that the current absorbed by inputs E1 and E2 can be neglected. The arrangement of the operational amplifier in a loop with the current sources TX1 and TX2 has also the effect that it may be considered that Vx1=Vx2, where Vx1 denotes the voltage value prevailing at the first input E1 of operational amplifier A and where Vx2 denotes the voltage value prevailing at the second input E2 thereof.

Comparing the functional block diagram of source 4X of FIG. 1 with the example of implementation of source 4X of FIG. 4, it shall be appreciated that diodes DX1 and DX2 of FIG. 4 respectively implement the two P-N junctions DX1 and DX2, respectively, shown at the bottom left of FIG. 1 and which provide ΔVbeX. In the same time, the P-N junction DX of FIG. 1, which provides VbeX, is implemented by, e.g., diode DX1 of FIG. 4.

Basic equations of voltages and currents in the respective branches of the circuit comprising the resistors and diodes give:

Vx1=Vbe(DX1)=RX0.iX1 (3)

Vx2=Vbe(DX2)+RX2.iX2=RX1.iX1 (4)

where Vbe(DX1) denotes forward voltage drop of the P-N junction DX1 having, e.g. a negative temperature drift, and Vbe(DX2) denotes the forward voltage drop of the P-N junction DX2; and,

iX1=Vbe(DX1)/RX0 (5)

iX2=[Vbe(DX1)−Vbe(DX2)]/RX2=ΔVbeX/RX2 (6)

where ΔVbeX denotes the difference Vbe(DX1)−Vbe(DX2), having a positive voltage drift as explained above in contrast to Vbe(DX1) as noted above.

The currents through the first and second PMOS transistors TX1 and TX2 are of same value, since the transistors are identical and receive identical voltages at their respective gate and source terminals. This current value being denoted IbiasX, it comes:

IbiasX=Ix1+Ix2=VbeX/RX0+ΔVbeX/RX2 (7)

which may also be written as follows:

$$IbiasX = \frac{1}{RX 0} [ VbeX + \frac{RX 0}{RX2} Δ VbeX ] \qquad ( 8 )$$

where

$$\frac{RX 0}{RX 2}$$

corresponds to first weighting coefficient K1 of FIG. 1.

K1 coefficient may be chosen so as to provide a compensation of the temperature drifts of VbeX and ΔVbeX, as explained in the foregoing description of FIG. 1.

Therefore, the respective values of resistors RX2 and RX0 are chosen in order to obtain the appropriate value for the ratio K1. As RX0 is a variable resistor, adjusting the value of the variable transistors RX0 and RX1 has an influence on the ratio RX0/RX2, thereby K1 can be adjusted by varying simultaneously RX0 and RX1.

The implementation of the second bandgap voltage source 4Y may be similar to the implementation of the first bandgap voltage source 4X as described above.

The same description thus applies, replacing letter ‘X’ by letter ‘Y’ in the voltage names and reference signs, where appropriate.

As previously indicated, however, the P-N junctions DY1 and DY2 of the bandgap voltage source 4Y may be formed by diode-connected bipolar transistors of a conduction type which is different from the conduction type of the P-N junction of the diode-connected bipolar transistors DX1 and DX2 of the first bandgap voltage source 4X. In the shown example, DY1 and DY2 may thus be N-type transistors, e.g. NPN bipolar transistors, since DX1 and DX2 are P-type transistors, e.g. PNP bipolar transistors.

The second bandgap voltage source 4Y may thus comprise two identical NMOS transistors, namely a first NMOS transistor TY1 and a second NMOS transistor TY2, and an operational amplifier A. Resistors RY0 and RY1 have an identical value. And resistors RY0 and RY1 are, in the shown example, variable resistors.

The basic equations of the second bandgap 4Y give:

Vy1=Vbe (DY1)=RY0.iY1 (9)

Vy2=Vbe (DY2)+RY2.iY2=RY1.iY1 (10)

and:

iY1=Vbe (DY1)/RY0 (11)

iY2=[Vbe(DY1)−Vbe(DY2)]/RY2=ΔVbeY/RY2 (12)

where ΔVbeY denotes the difference: Vbe(DY1)−Vbe(DY2) with a negative voltage drift.

IbiasY denoting the same value of currents going through both the first and second PMOS transistors TY1 and TY2, respectively, it comes:

IbiasY=Iy1+Iy2=VbeY/RY0+ΔVbeY/RY2 (13)

which may also be written as:

$$IbiasY = \frac{1}{RY 0} [ VbeY + \frac{RY 0}{RY 2} Δ VbeY ] \qquad ( 14 )$$

where

$$\frac{RY 0}{RY 2}$$

corresponds to first weighting coefficient K2 of FIG. 1

the value of weighting coefficient K2 may be chosen as to provide a compensation of the temperature drifts of VbeY and ΔVbeY, as already explained in the foregoing.

Therefore, the values of resistor RY2 and RY0 may be chosen to give the appropriate value to the ratio K2.

As RY0 is a variable resistor, adjusting the value of the variable transistors RY0, RY1 influence the ratio RY0/RY2, and therefore K2 can be adjusted by varying simultaneously RY0 and RY1.

Turning now to the example of implementation of the adding circuit 5 shown in FIG. 4, it shall be appreciated that, in the shown example, currents rather than voltages are added.

The adding circuit 5 may thus comprise a first voltage-to-current converter such as, for instance a MOS transistor, e.g. a PMOS transistor TX3, receiving the first bandgap voltage VbgX on its control gate. It may further comprise a second voltage-to-current converter such as, for instance a MOS transistor, e.g. a PMOS transistor TY3, receiving the second bandgap voltage VbgY on its control gate. TX3 may be of same type as TX1, but the size of its control gate may be different for that of TX1. Similarly TY3 may be of same type as TY1, the size of the control gates of these transistors being different.

The source terminals of TX3 and TY3 may be connected to the positive voltage supply, to receive the supply voltage Vss. Their drain terminals may be connected together and to the ground Gnd through a resistor RZ. The output of the reference voltage circuit 9 may be taken on the common drain terminals of TX3 and TY3. As may be appreciated, resistor RZ operates as a current-to-voltage converter.

The weighting coefficients Kx and Ky of FIG. 1 may be determined by adjusting the common value of the variable resistors RX0 and RX1 relative to the common value of resistors RY1 and RY0. In a variant, it is also possible to adjust the common value of the variable resistors RY0 and RY1 relative the common value of resistors RX1 and RX0.

The difference between the size of the gate of TX3 (resp. TY3) and the size of the gate of TX1 and TX2 (resp. TY1 and TY2) may also define the weighting coefficients Kx (resp. Ky) of the adding circuit 5. Stated otherwise, the transistors TX3 and TY3 are sized to define the weighting coefficients Kx and Ky. For example, we have:

IrefX=Kx.IbiasX (15)

where Kx is the weighting coefficient defined by the ratio of the size of the gate of TX3 to the size of the gate of TX1 and TX2.

In the same manner, we have:

IrefY=Ky.IbiasY (16)

where Ky is the weighting coefficient defined by the ratio of the size of the gate of TY3 to the size of the gate of TY1 and TY2.

It shall be noted that a combination of the two options mentioned above for the setting of the weighting coefficient Kx and Ky may also be implemented in any manner suitable for the specific implementation. Indeed, the effect of the difference in size of the transistors on the value of coefficients Kx and Ky, cumulates with the effect of the ratio between the common value of resistors RX0 and RX1 and the common value of resistors RY1 and RY0.

The output of the adding circuit 5 gives:

Iref=IrefX+IrefY=Kx.IbiasX+Ky.IbiasY (17)

that is to say, also:

$$Iref = Kx \cdot \frac{1}{RX 0} [ VbeX + \frac{RX 0}{RX 2} Δ VbeX ] + Ky \cdot \frac{1}{RY 0} [ VbeY + \frac{RY 0}{RY 2} Δ VbeY ] \qquad ( 18 )$$

where Iref is the current output by the common drain terminals of TX3 and TY3, and corresponds to the output signal of the reference voltage generation circuit 9.

The voltage Vref output by the reference voltage generation circuit 9 may thus be expressed as:

Vref=RZ.Iref (19)

As shown in FIG. 3 already described above, VbgX exhibits a positive drift 91 with regard to the strain S at the die level, whereas VbgY shows a negative drift 92 with regard to the same strain S at the die level. The output reference voltage Vref of the addition circuit 5 exhibits a very small drift 93 as a function of the strain S, thereby achieving an outstanding accuracy, whatever the strain applied to the die.

It may be noted that the resistors RX0, RX1, RY0 and RY1 being variable resistors, the conditions RX0=RX1 and RY0=RY1 may be satisfied, for instance, by having the control signals received by the corresponding pairs of MOS transistors which implement these resistors being identical.

This allows setting the value of K1 and K2 in order to improve the temperature compensation, as already explained.

Moreover, one of the two bandgap voltage sources 4X and 4Y have a higher weighting coefficient than the other, for example Ky>Kx.

Therefore, with regard to the temperature compensation, the tuning of RY0=RY1 may provide a coarse tuning, whereas the tuning of RX0=RX1 may provide a fine tuning of the strain compensation between bandgap voltage sources 4X and 4Y.

FIG. 5 and FIG. 6 show an integrated circuit 1 comprising a reference voltage generation circuit 9 as defined above. In FIG. 5, the integrated circuit 1 is viewed from the top in a plane sectional view. In FIG. 6, the integrated circuit 1 is shown in a cross sectional view.

The integrated circuit 1 comprises a die 2, e.g. a semiconductor substrate on which the reference voltage generating circuit 9 is implemented. The die 2 may be housed, e.g. in a plastic package 8 which may be overmoulded onto the die 2. The process of overmoulding, as such, may sometimes create mechanical stress on the die, which may yield, e.g. in a bending of the die 2, as illustrated in an exaggerated manner on FIG. 5. This mechanical stress creates a strain S, symbolised in FIG. 6 by an arrow, and whose effect on the value of the generated reference voltage may be compensated thanks to embodiments as described herein.

In the shown example, the two bandgap voltage sources 4X and 4Y of the circuit 9 are implemented in the same layer or layers of the semiconductor device. However, as already mentioned in the above, other configurations may be suitable for the specific implementation, depending on the manufacturing technology.

The die 2 comprises a reference voltage generation circuit 9 as described above. It shall be noted that there may be other functions implemented in the die. For example, the reference voltage generated by the reference voltage generation circuit 9 may be part of, or cooperate with an analog-to-digital conversion circuit, which may be used for generating digital values of a voltage or current sensed by an analog sensing circuit. The accuracy of the reference voltage improves the quality and accuracy of the analog sensing and therefore the accuracy of the analog-to-digital converted sensed value.

Referring to FIG. 7, the integrated circuit 1 may be integrated in a battery sensing device 33 arranged to provide measures of an operational voltage and an operational temperature of the battery, e.g. to a power management apparatus in a vehicle. The device 33 may be arranged to measure a current flowing to or from the battery. To that end, the device 33 may be arranged in a housing 30 coupled to, e.g. connected to a battery connection wire 32 which may be connected to a battery contact stud through a battery lug 31.

1. A reference voltage generating circuit comprising:
a first bandgap voltage source arranged to output a first bandgap voltage exhibiting a first type deviation in response to a strain applied at die level in a given direction,
a second bandgap voltage source arranged to output a second bandgap voltage and exhibiting a second type deviation in response to a strain applied at die level in the given direction, said second type deviation being opposite to the first type deviation of the first bandgap voltage, and
an adding circuit arranged to add the first bandgap voltage and the second bandgap voltage, and to output a temperature drift and strain drift compensated reference voltage.

2. The circuit of claim 1, wherein:
the first bandgap voltage source comprises a first P-N junction having a first forward voltage drop which exhibits the first type voltage deviation in response to the strain applied in the given direction; and,
the second bandgap voltage source comprises a second P-N junction having second forward voltage drop which exhibits the second type voltage deviation in response to the strain applied in the given direction.

3. The circuit of claim 2, wherein the first P-N junction is formed by a diode-connected bipolar transistor or the second P-N junction is formed by a diode-connected bipolar transistor.

4. The circuit of claim 3, wherein the first P-N junction is formed by a diode-connected bipolar transistor of a first conduction type and the second P-N junction is formed by a diode-connected bipolar transistor of a second conduction type, different from said first conduction type.

5. The circuit of claim 4, wherein the first P-N junction is formed by a diode-connected PNP bipolar transistor and the second P-N junction is formed by a diode-connected NPN bipolar transistor.

6. The circuit of claim 1, wherein the first bandgap voltage source or the second bandgap voltage source are arranged to perform a first order and second order temperature drift compensation.

7. The circuit of claim 1, wherein the adding circuit is arranged to apply first and second weighting coefficients to the first and second bandgap voltages, respectively.

8. The circuit of claim 7, wherein the first weighting coefficient is different from the second weighting coefficient.

9. The circuit of claim 7, wherein the adding circuit comprises a first transistor having a control terminal receiving the first bandgap voltage and a second transistor having a control terminal receiving the second bandgap voltage, and wherein the output of the reference voltage circuit is taken on common terminals of said first and second transistors.

10. The circuit of claim 9 wherein the first and second transistors are sized to obtain desired values of the first and second weighting coefficients.

11. The circuit of claim 1, wherein the first bandgap voltage source or the second bandgap voltage source each comprises:
first and second current mirrored branches, comprising a first transistor and a second transistor mirrored with said first transistor, respectively, said first and second transistor being arranged as current sources controlled by one and the same control signal; and,
an operational amplifier, arranged to provide the control signal for the currents sources, wherein
the first current mirrored branch further comprises a first diode arranged between the first transistor and the ground, and the second current mirrored branch further comprises a second diode in series with an associated resistor arranged between the second transistor and the ground,
a first node between the first transistor and the first diode is connected to the ground via a first resistor, and a second node between the second transistor on one side and the second diode and associated resistor on the other side, is connected to the ground via a second resistor, and
the operational amplifier is arranged to output the control signal as a function of the difference between voltage at the first node and the voltage at the second node.

12. The circuit of claim 11, wherein the first or second transistors each comprises a Field Effect Transistor.

13. The circuit of claim 11, wherein the first diode or the second diode each comprises a diode-connected transistor.

14. The circuit of claim 11, wherein the first and second resistors are variable resistors.

15. The circuit of claim 14 wherein the value of the first and second resistors is controlled to obtain desired values of the first and second weighting coefficients.

16. The circuit of claim 11, wherein the first and second resistors have the same resistance value.

17. The circuit of claim 11, wherein the first resistor and/or the second resistor each comprises a MOS transistor controlled in the conduction zone of operation.

18-20. (canceled)
